(19) United States
(12) Patent Application Publication
(10) Pub. No.: US 2021/0150723 A1
(43) Pub. Date: May 20, 2021

(54) IMAGE PROCESSING DEVICE, IMAGE PROCESSING METHOD, AND PROGRAM

(71) Applicant: SONY CORPORATION, Tokyo (JP)

(72) Inventors: Koji NISHIDA, Tokyo (JP); Kenichiro HOSOKAWA, Kanagawa (JP); Takuro KAWAI, Tokyo (JP)

(73) Assignee: SONY CORPORATION, Tokyo (JP)

(21) Appl. No.: 17/048,305

(22) PCT Filed: May 9, 2019
(86) PCT No.: PCT/JP2019/018482

§ 371 Date: Oct. 16, 2020

(30) Foreign Application Priority Data
May 22, 2018 (JP) 2018-097606

(51) Int. Cl. G06T 7/11; G06T 7/73; G06T 7/215

(52) U.S. Cl. CPC G06T 7/11; G06T 2207/10016; G06T 7/215; G06T 7/73

(57) ABSTRACT

There is provided an image processing device, an image processing method, and a program that make it possible to swiftly perform segmentation of video images. The image processing device according to an aspect of the present technology sets superpixels for frames included in a video image. The superpixels are regions including a plurality of pixels. Further, as information regarding each of the superpixels in a predetermined frame, the image processing device inherits and sets information regarding a corresponding one of the superpixels in a frame earlier than the predetermined frame. The present technology is applicable to various kinds of equipment for processing video images.

### TECHNICAL FIELD

The present technology relates to an image processing device, an image processing method, and a program, and more particularly to an image processing device, an image processing method, and a program that make it possible to swiftly perform segmentation of video images.

### BACKGROUND ART

A process called “segmentation” is performed in some cases as preprocessing, for example, for recognizing an object depicted in an image. Segmentation is a process of dividing an image into regions including significant pixels, such as regions depicting the same object.

### CITATION LIST

### Patent Literature

[PTL 1]
Japanese Patent Laid-open No. 2016-171558

### Non Patent Literature

### [NPL 1]

R. Achanta et al: “SLIC superpixels compared to state-of-the-art superpixel methods,” IEEE Transactions on Pattern Analysis and Machine Intelligence, Vol. 34 (2012), pp. 2274-2282.

### [NPL 2]

M. Reso et al.: “Temporally Consistant Superpixels,” Proceedings of the 2013 IEEE International Conference on Computer Vision (ICCV '13), pp. 385-392

### SUMMARY

### Technical Problem

A conventional segmentation algorithm is such that an iterative calculation is used in a frame and in a sequence (NPL 1 and NPL 2). From the viewpoint of calculation amount and circuit scale, it is difficult to perform iterative calculations on video images in real time.

The present technology has been made in view of the above circumstances, and makes it possible to swiftly perform segmentation of video images.

### Solution to Problem

An image processing device according to an aspect of the present technology includes a setting section that sets superpixels for frames included in a video image, the superpixels being regions including a plurality of pixels; and an information setting section that, as information regarding each of the superpixels in a predetermined frame, inherits and sets information regarding a corresponding one of the superpixels in a frame earlier than the predetermined frame.

According to an aspect of the present technology, the superpixels, which are regions including a plurality of pixels, are set for frames included in a video image, and, as information regarding each of the superpixels in a predetermined frame, information regarding a corresponding one of the superpixels in a frame earlier than the predetermined frame is inherited and set.

### Advantageous Effect of Invention

The present technology makes it possible to swiftly perform segmentation of video images.

It should be noted that the advantage described here is merely illustrative and not restrictive. The present technology may provide any advantages described in the present disclosure.

### BRIEF DESCRIPTION OF DRAWINGS

FIG. 1 is a block diagram illustrating a configuration example of an image processing device according to an embodiment of the present technology.

FIG. 2 is a set of diagrams illustrating an example of segmentation.

FIG. 3 is a block diagram illustrating a configuration example of a segmentation processing section depicted in FIG. 1.

FIG. 4 is a diagram illustrating an example setting of initial superpixels.

FIG. 5 is a diagram illustrating an example of motion vectors.

FIG. 6 is a diagram illustrating a search example for superpixels.

FIG. 7 is a diagram illustrating an example of determining an initial superpixel as an affiliation.

FIG. 8 is a diagram illustrating examples of superpixels.

FIG. 9 is a flowchart illustrating a segmentation process.

FIG. 10 is a flowchart illustrating the segmentation process subsequent to the flowchart of FIG. 9.

FIG. 11 is a block diagram illustrating a configuration example of a feature amount calculation section depicted in FIG. 1.

FIG. 12 is a diagram illustrating an example of determining correlated superpixels.

FIG. 13 is a flowchart illustrating a feature amount calculation process.

FIG. 14 is a flowchart illustrating the feature amount calculation process subsequent to the flowchart of FIG. 13.

FIG. 15 depicts diagrams illustrating examples of equipment in which the image processing device is mounted.

FIG. 16 is a block diagram illustrating a configuration example of a computer.

### DESCRIPTION OF EMBODIMENTS

Embodiments for implementing the present technology will now be described. The description will be given in the following order.

1. Configuration of Image Processing Device

2. Segmentation

3. Feature Amount Calculation

4. Other

### <<1. Configuration of Image Processing Device>>

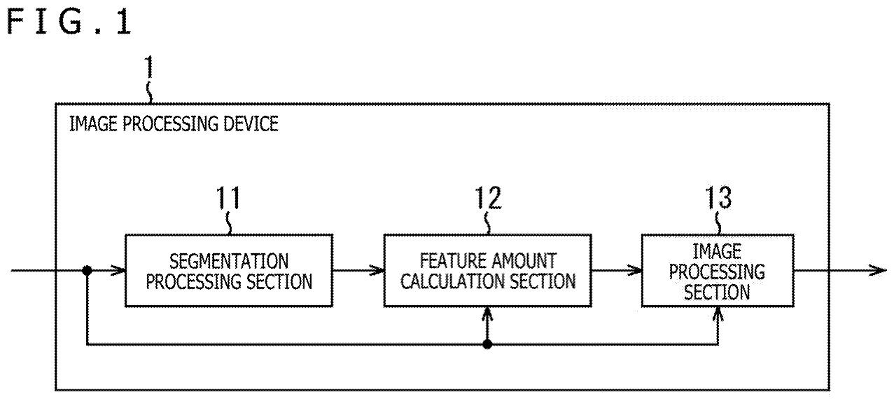

FIG. 1 is a block diagram illustrating a configuration example of an image processing device according to an embodiment of the present technology.

As depicted in FIG. 1, an image processing device 1 includes a segmentation processing section 11, a feature amount calculation section 12, and an image processing section 13.

The image processing device 1 includes, for example, a semiconductor chip or a circuit board on which a semiconductor chip is mounted. The image processing device 1 is disposed in a TV set (television receiver) or other image processing equipment. At least the segmentation processing section 11 and the feature amount calculation section 12 are configured as processing sections that use hardware to perform a process. The image processing device 1 further includes, as needed, processing sections for performing some other processes.

Video image data is inputted to the image processing device 1. The inputted video image data is supplied to the segmentation processing section 11, the feature amount calculation section 12, and the image processing section 13.

The segmentation processing section 11 performs segmentation of each of frames included in a video image. Segmentation is a process of dividing an image into regions including significant pixels, such as regions depicting the same state of a certain object.

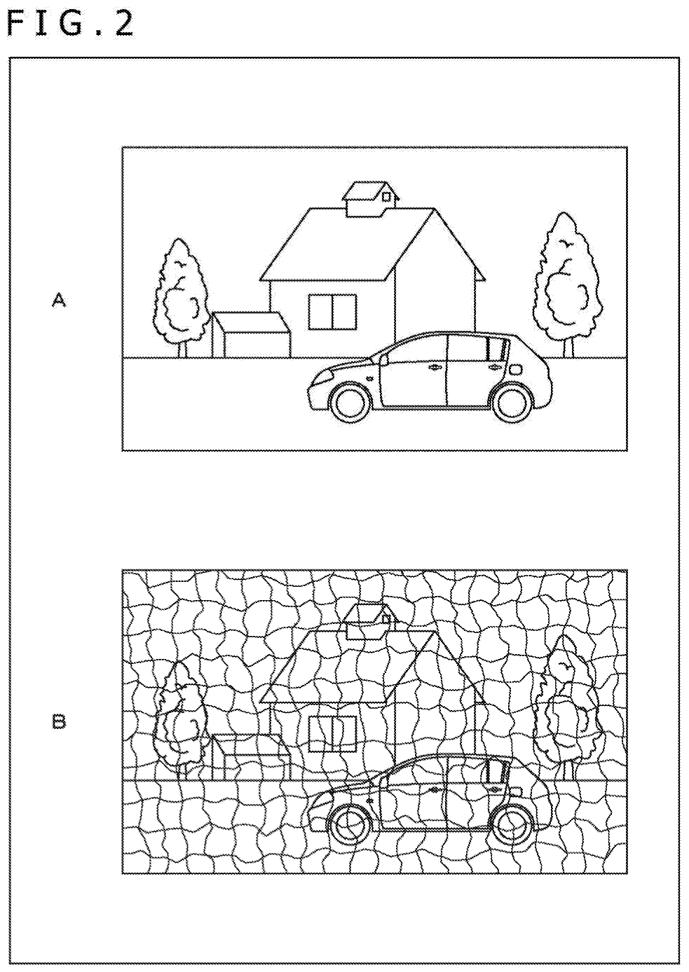

FIG. 2 is a set of diagrams illustrating an example of segmentation.

An image depicted in A of FIG. 2 is an image representing one frame included in a video image inputted to the image processing device 1. The example in A of FIG. 2 depicts an automobile with a predetermined landscape scene in the background.

In the above case, the segmentation processing section 11 performs segmentation to group pixels having similar features together and set a plurality of regions as depicted in B of FIG. 2. Each of the regions set by segmentation is referred to as a superpixel.

The segmentation processing section 11 outputs superpixel information, which is information regarding each superpixel, to the feature amount calculation section 12 as the result of segmentation.

The superpixel information includes the pixel value of a superpixel, the coordinates of the superpixel, and information indicative of pixels affiliated to the superpixel.

The pixel value of the superpixel is, for example, determined as the average pixel value of the pixels affiliated to the superpixel. Further, the coordinates of the superpixel are, for example, determined as the average coordinate values of the pixels affiliated to the superpixel. The average coordinate values of the pixels affiliated to the superpixel represent the center coordinates of the superpixel.

As described above, the segmentation processing section 11 uses hardware to perform segmentation of each frame included in a video image in real time. The segmentation processing section 11 sequentially outputs the superpixel information regarding individual frames included in the video image.

The feature amount calculation section 12 calculates the feature amount of each frame included in the video image. For example, the feature amount calculation section 12 calculates the feature amount of each pixel included in a frame as the local feature amount, and adds up the local feature amount of pixels included in the same superpixel in order to calculate the feature amount of each superpixel.

The feature amount calculation section 12 sets a superpixel feature amount, which is the feature amount of each superpixel, as the feature amount of each pixel, and outputs the feature amount of each pixel to the image processing section 13. As a superpixel is, for example, a region of pixels depicting the same state, the feature amount of each superpixel represents the feature amount of such a state.

The feature amount calculation section 12 also outputs, as needed, the feature amount of all frames, which is determined based on the superpixel feature amount. As described later, the feature amount calculation section 12 additionally performs, for example, a weighting process by using the feature amount of surrounding superpixels.

Based on the feature amount supplied from the feature amount calculation section 12, the image processing section 13 performs different image processes on, for example, regions depicting the same object. In the example of FIG. 2, different image processes are performed, for example, on the region of the automobile and on the region of the landscape scene. The image processing section 13 performs various image processes such as a super-resolution process, a color gamut expansion process, and a brightness extension process.

The video image data subjected to image processing in the image processing section 13 is outputted to the outside of the image processing device 1, and variously processed by processing sections at an output destination.

### <<Segmentation>>

### <General Segmentation>

General segmentation will now be described.

SLIC (Simple Linear Iterative Clustering) described in NPL 1, which is described earlier, is a segmentation method using superpixels. SLIC is a method of ensuring the accuracy of segmentation by repeatedly performing two processes, namely, an assignment process and an update process, as iterative processing.

In SLIC, the number of superpixels is fixed. For example, initial superpixels are set by dividing one frame into P×Q blocks that is fixed in number. Under normal conditions, the center coordinates (x,y) of each block and the YUV value (Y,U,V) of the center coordinates form an initial center value (x,y,Y,U,V).

The “assignment process” assigns each pixel included in a frame to any one of P×Q superpixels. In the first assignment process, each pixel is assigned to any one of the initial superpixels.

A superpixel to which a pixel is to be assigned is determined in accordance with a distance based on the coordinates (x,y) and pixel value (Y,U,V) of the pixel and the center value (x,y,Y,U,V) of the superpixel. For example, each pixel is assigned to a superpixel that is closest in distance.

The “update process” updates the center value of each superpixel (the initial center value of an initial superpixel in the case of the first update process). The update process is performed each time the assignment of all pixels is terminated.

The center value is updated for each superpixel by determining the average of the coordinates (x,y) and the average of pixel values (Y,U,V) of pixels affiliated to a superpixel and setting the determined average values as a new center value (x,y,Y,U,V).

SLIC is a method of repeatedly performing the two processes, namely, the assignment process and the update process, N times for each frame. It is difficult to perform such processes on video images by using hardware.

In the segmentation processing section 11 of the image processing device 1, the accuracy of segmentation can be ensured by deploying iterative processing in what is called the time direction so as to perform the assignment process and update process only once. In a situation where processing can be performed in real time, the assignment process and update process can be performed M or more times (two or more times).

### <Configuration of Segmentation Processing Section>

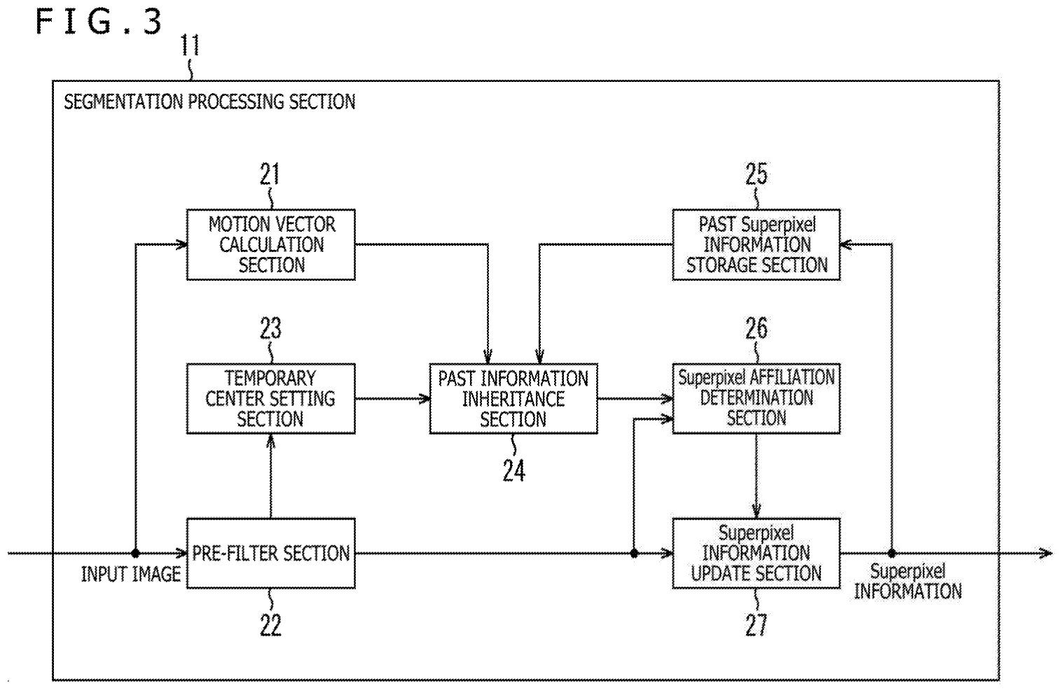

FIG. 3 is a block diagram illustrating a configuration example of the segmentation processing section 11 depicted in FIG. 1.

The segmentation processing section 11 includes a motion vector calculation section 21, a pre-filter section 22, a temporary center setting section 23, a past information inheritance section 24, a past superpixel information storage section 25, a superpixel affiliation determination section 26, and a superpixel information update section 27. Each frame included in a video image is supplied, as an input image, to the motion vector calculation section 21 and the pre-filter section 22.

The motion vector calculation section 21 calculates a motion vector of each location in the input image, for example, by checking for a match with preceding and succeeding frames. The motion vector of each predetermined range, for example, of 4×4 pixels or 8×8 pixels is determined. Information regarding the motion vector determined by the motion vector calculation section 21 is supplied to the past information inheritance section 24.

The pre-filter section 22 performs pre-filter processing on the input image by using an LPF such as an averaging filter. The input image subjected to pre-filter processing is supplied to the temporary center setting section 23, the superpixel affiliation determination section 26, and the superpixel information update section 27.

The temporary center setting section 23 sets initial superpixels for the input image. The temporary center setting section 23 divides the whole input image into a predetermined number of block-shaped regions, for example, of 100×100 (vertically×horizontally), and sets each region as an initial superpixel.

As described above, initial superpixel setup is performed on an individual frame basis each time a frame included a video image is inputted. The temporary center setting section 23 functions as a setting section that sets the initial superpixels for each frame included in a video image.

Further, the temporary center setting section 23 sets the initial center value (x,y,Y,U,V) based on the center coordinates (x,y) of each initial superpixel and the YUV value (Y,U,V) of the center coordinates. The center value, which is information regarding a superpixel, contains information regarding a pixel value and information regarding coordinates.

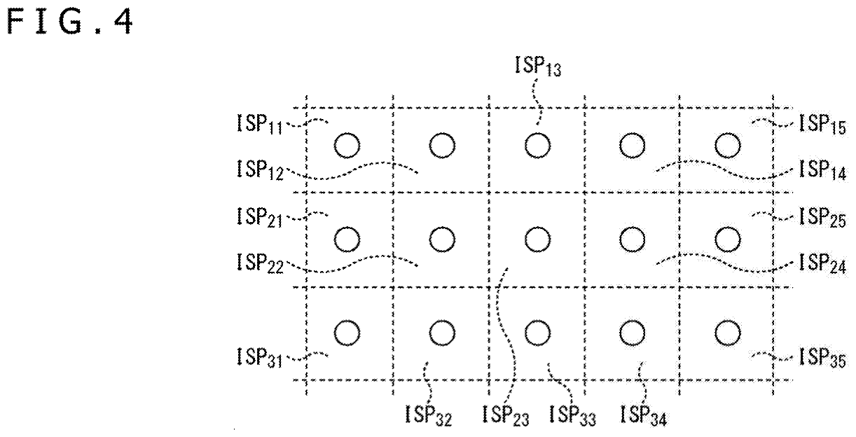

FIG. 4 is a diagram illustrating an example of initial superpixels.

The example in FIG. 4 depicts the ranges of a total of 15 initial superpixels (ISPs (Initial Superpixels)), namely, ISP₁₁ to ISP₁₅, ISP₂₁ to ISP₂₅, and ISP₃₁ to ISP₃₅. The broken lines in FIG. 4 represent the boundaries of the individual initial superpixels. A circle inside each initial superpixel indicates its central position.

Information regarding the initial superpixels, which are set in the above-described manner, is supplied from the temporary center setting section 23 to the past information inheritance section 24.

The past information inheritance section 24 searches the superpixels in a one-frame-preceding frame, which is a past frame, for a superpixel corresponding to each initial superpixel. An initial superpixel and a superpixel corresponding to the initial superpixel are superpixels depicting the same object. Information regarding each one-frame-preceding superpixel is held (stored) by the past superpixel information storage section 25.

More specifically, the past information inheritance section 24 performs motion compensation on each initial superpixel in accordance with the reversal of the motion vector calculated by the motion vector calculation section 21. Further, the past information inheritance section 24 searches one-frame-preceding superpixels for a superpixel positioned closest to a motion-compensated location, and determines the superpixel retrieved by search as a corresponding superpixel.

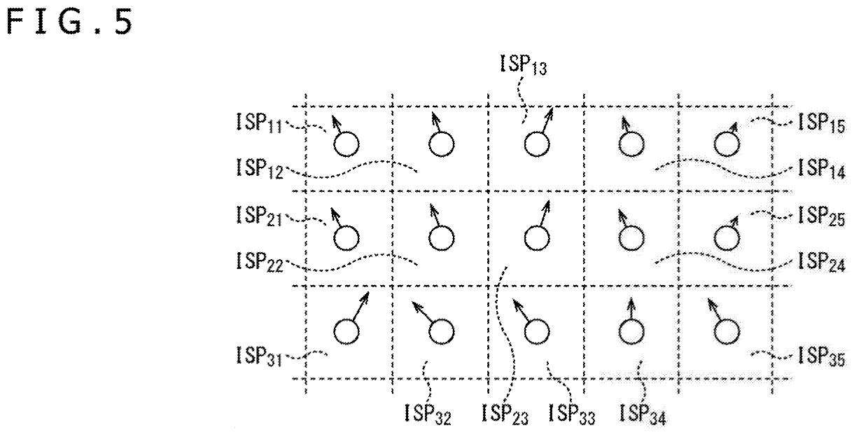

FIG. 5 is a diagram illustrating an example of motion vectors.

As indicated by the arrows in FIG. 5, the past information inheritance section 24 determines the motion vector of each initial superpixel in accordance with the motion vector of each location calculated by the motion vector calculation section 21. Motion compensation is performed on each initial superpixel in accordance with the reversal of the determined motion vector.

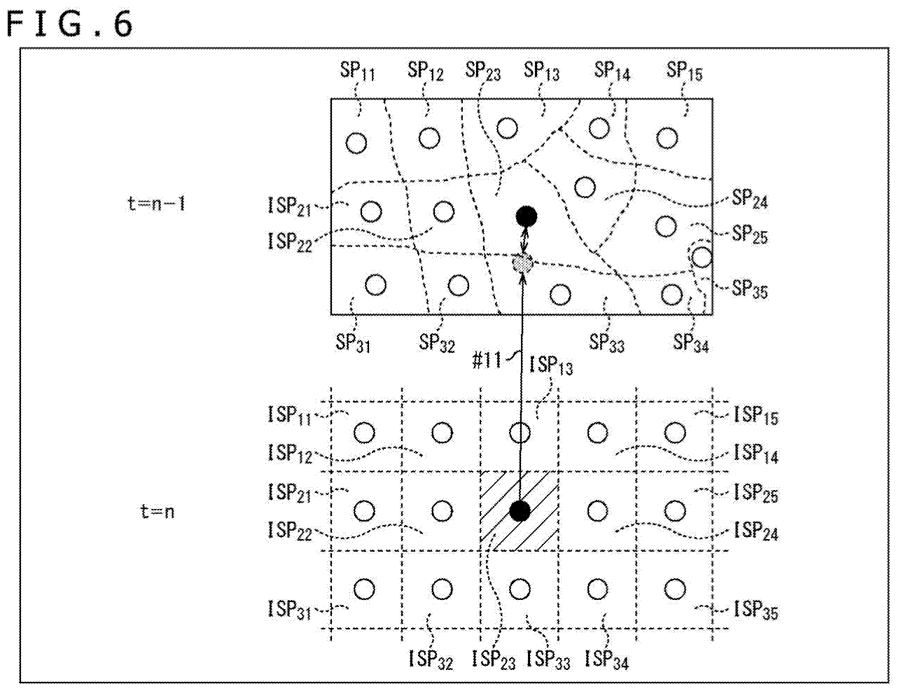

FIG. 6 is a diagram illustrating a search example for a corresponding superpixel.

The lower half of FIG. 6 depicts the ranges of some initial superpixels set in a frame at time t=n. The ranges of the initial superpixels depicted in FIG. 6 are the same as the ranges described with reference to FIG. 3.

Further, the upper half of FIG. 6 depicts the ranges of some superpixels set in a frame at time t=n−1. As the center value is updated, regions not shaped like blocks are set as superpixels as depicted in the upper half of FIG. 6. The example in FIG. 6 depicts the ranges of a total of 15 superpixels, namely, SP₁₁ to SP₁₅, SP₂₁ to SP₂₅, and SP₃₁ to SP₃₅.

For example, in a case where ISP₂₃, which is an initial superpixel, is regarded as a target of interest, motion compensation is performed on ISP₂₃.

In a case where the motion-compensated central position of ISP₂₃ is the position of the broken-line circle pointed to by the arrow #11, the distance between the motion-compensated center of ISP₂₃ and the center of each surrounding superpixel is calculated, and the closest superpixel, such as SP₂₃, is determined as a superpixel corresponding to ISP₂₃.

In the past information inheritance section 24, the above-described superpixel search is performed on each initial superpixel.

The range targeted for distance calculation is preset as the range of superpixels within a predetermined range based, for example, on the motion-compensated central position of ISP₂₃. Limiting the range targeted for distance calculation makes it possible to reduce the cost of calculation required for superpixel search.

In a case where a one-frame-preceding superpixel corresponding to an initial superpixel is determined, the past information inheritance section 24 depicted in FIG. 3 sets a value based on the center value (x,y,Y,U,V) of the corresponding superpixel as the initial center value (x,y,Y,U,V) of the initial superpixel (by copying for replacement).

Stated differently, information regarding the center value is inherited by considering the initial superpixel as an inheritance destination and considering the one-frame-preceding corresponding superpixel as an inheritance source.

For example, the past information inheritance section 24 performs setup in such a manner that the pixel value (Y,U,V) included in the initial center value (x,y,Y,U,V) of the inheritance-destination initial superpixel is equal to the pixel value (Y,U,V) included in the center value (x,y,Y,U,V) of the inheritance-source superpixel.

Further, as for the coordinates (x,y) included in the initial center value (x,y,Y,U,V) of the inheritance-destination initial superpixel, the past information inheritance section 24 performs motion compensation on the coordinates (x,y) included in the center value (x,y,Y,U,V) of the inheritance-source superpixel, and then sets the motion-compensated coordinates (x,y). Motion compensation on the coordinates (x,y) is performed by using, for example, the motion vector of the initial superpixel.

The past information inheritance section 24 performs center value setup as described above for all initial superpixels, and outputs information regarding the inherited center value, which is the center value of each initial superpixel, to the superpixel affiliation determination section 26. The past information inheritance section 24 functions as an information setting section for inheriting and setting information regarding a superpixel in a past frame as the information regarding an initial superpixel.

It should be noted that, in a case where the closest superpixel is not found among one-frame-preceding superpixels, the initial center value of the initial superpixel is outputted as is.

Instead of selecting a superpixel positioned closest to the motion-compensated location as the inheritance-source superpixel, the inheritance-source superpixel may be selected by performing weighting in accordance with the relative positional relationship between the location of an initial superpixel and the location of each one-frame-preceding superpixel. As a result, a superpixel having similar coordinate values is likely to be selected as the inheritance-source superpixel. This enables the past information inheritance section 24 to increase the accuracy of center value inheritance.

The superpixel affiliation determination section 26 calculates the distance between each pixel in the input image supplied from the pre-filter section 22 and each initial superpixel. Based on the calculated distance, the superpixel affiliation determination section 26 assigns each pixel in the input image to one of the initial superpixels.

The distance calculated in the above instance is the distance calculated by using both the pixel value (Y,U,V) and coordinates (x,y) included in the center value, and is different from the distance calculated by the past information inheritance section 24 for determining the inheritance-source superpixel. The distance calculated by the past information inheritance section 24 for determining the inheritance-source superpixel is the distance determined based on the coordinates (x,y).

The superpixel affiliation determination section 26 assigns each pixel to the closest initial superpixel for the purpose of determining the initial superpixel to which each pixel is to be affiliated.

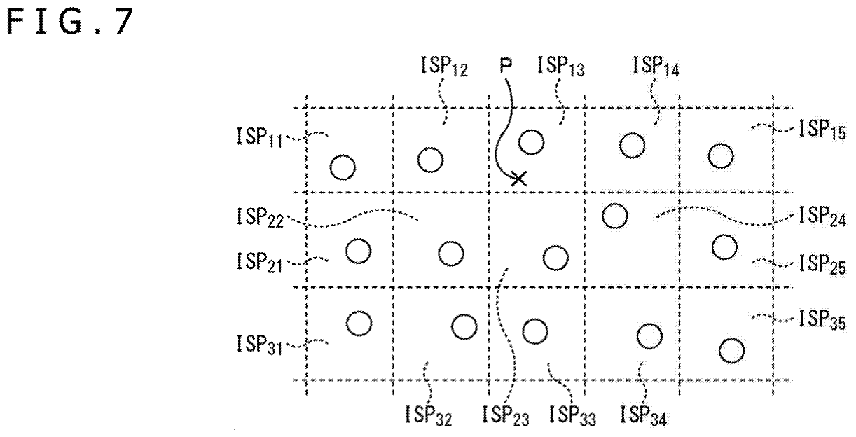

FIG. 7 is a diagram illustrating an example of determining an initial superpixel as an affiliation.

The example in FIG. 7 depicts the ranges of a total of 15 initial superpixels described with reference, for example, to FIG. 4, namely, ISP₁₁ to ISP₁₅, ISP₂₁ to ISP₂₅, and ISP₃₁ to ISP₃₅. A value based on the center value of the inheritance-source superpixel is set as the center value of each initial superpixel. It should be noted that the location indicated by the center value of each initial superpixel in FIG. 7 represents a location determined by performing motion compensation on the coordinates of the center value of a one-frame-preceding inheritance-source superpixel.

In a case where a pixel P is regarded as a target of interest, a predetermined calculation is performed based on the pixel value (Y,U,V) and the coordinates (x,y), which are the values of the pixel P, and on the center values (x,y,Y,U,V) of surrounding initial superpixels (inherited center values). The distance between the pixel P and each surrounding initial superpixel is calculated.

The range targeted for distance calculation may be preset as the range of initial superpixels within a predetermined range based, for example, on the location of the pixel P. Limiting the range targeted for distance calculation makes it possible to reduce the cost of calculation required for determining an initial superpixel as an affiliation.

In a case where initial superpixels to which all pixels in the input image are to be affiliated are determined, the superpixel affiliation determination section 26 outputs, to the superpixel information update section 27, information indicative of an initial superpixel to which each pixel is to be affiliated. The above-described process of determining the initial superpixel to which each pixel in the input image is to be affiliated corresponds to the assignment process described earlier.

For each initial superpixel, the superpixel information update section 27 updates the center value (x,y,Y,U,V) of a superpixel by calculating the average of the pixel values (Y,U,V) of affiliated pixels and the average of the coordinates (x,y) and setting the calculated average values as the center value (x,y,Y,U,V) of the superpixel.

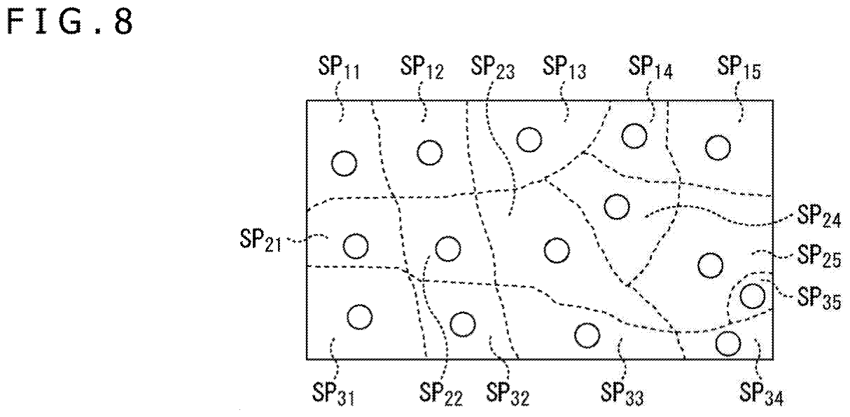

Updating the center value results in the formation of superpixels depicted, for example, in FIG. 8. A process of updating the center value after determining the affiliated pixels by the assignment process corresponds to the update process.

The superpixel information update section 27 outputs, as the result of segmentation, the superpixel information including the center value of each superpixel and identification information regarding superpixels to which all pixels included in the input image are to be affiliated. That is, information obtained by a single execution of the assignment and update processes is outputted as the result of segmentation. The superpixel information outputted from the superpixel information update section 27 is not only supplied to the feature amount calculation section 12, but also supplied to the past superpixel information storage section 25 for storage purposes. The superpixel information stored in the past superpixel information storage section 25 is used to process the next frame.

### <Operation of Segmentation Processing Section>

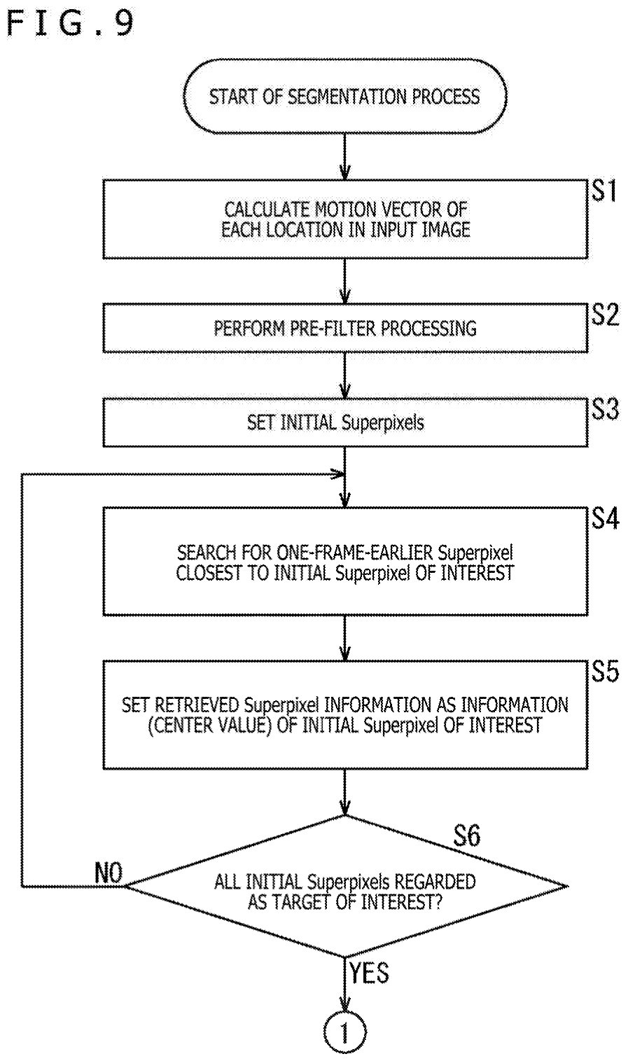

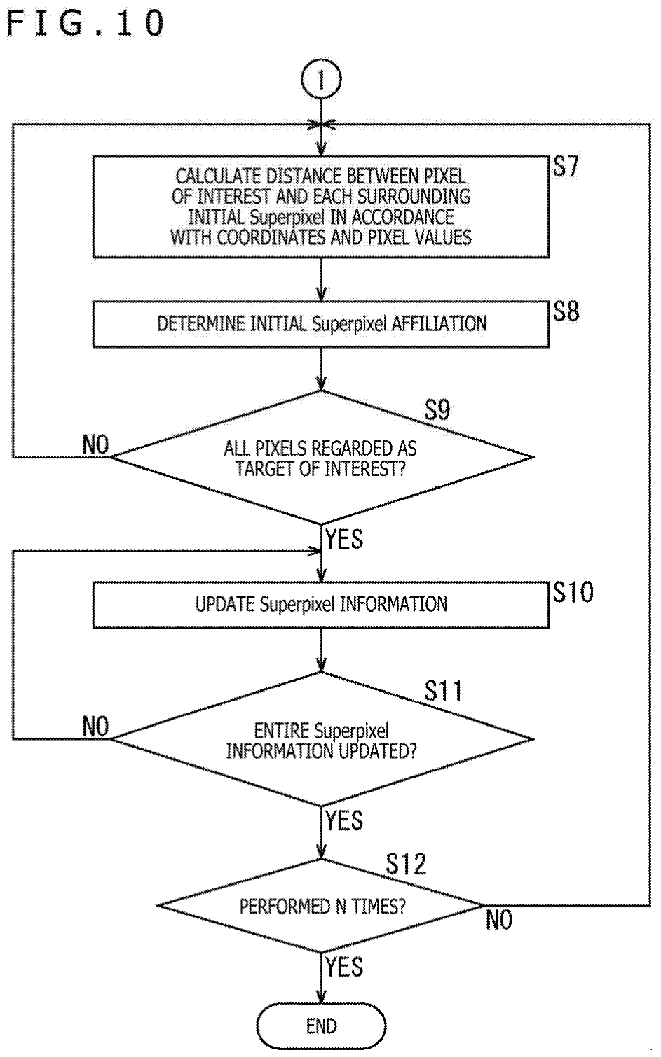

A segmentation process performed by the segmentation processing section 11 will now be described with reference to the flowcharts of FIGS. 9 and 10.

The process described in FIGS. 9 and 10 is performed each time a frame included in a video image is inputted.

In step S1, the motion vector calculation section 21 calculates the motion vector of each location in the input image.

In step S2, the pre-filter section 22 performs pre-filter processing on the input image by using an LPF such as an averaging filter.

In step S3, the temporary center setting section 23 not only sets a fixed number of initial superpixels for the input image, but also sets the initial center value (x,y,Y,U,V) of each initial superpixel.

In step S4, the past information inheritance section 24 regards one initial superpixel as a target of interest, and searches one-frame-preceding superpixels for a superpixel closest to the initial superpixel of interest. As a result of the above superpixel search, a one-frame-preceding superpixel positioned closest to the motion-compensated location of the initial superpixel of interest is determined as the corresponding superpixel.

In step S5, the past information inheritance section 24 inherits the center value (x,y,Y,U,V) of the superpixel determined by search, and sets the center value (x,y,Y,U,V) (inherited center value) of the initial superpixel of interest.

In step S6, the past information inheritance section 24 determines whether or not all initial superpixels have been regarded as a target of interest. In a case where it is determined in step S6 that all the initial superpixels have not been regarded as the target of interest, processing returns to step S4, switches to another initial superpixel of interest, and repeatedly performs processing in a similar manner.

Meanwhile, in a case where it is determined in step S6 that all the initial superpixels have been regarded as the target of interest, processing proceeds to step S7 (FIG. 10).

In step S7, the superpixel affiliation determination section 26 regards a predetermined pixel included in the input image as a target of interest, and calculates the distance between the pixel of interest and each initial superpixel. The distance is calculated by using both the pixel value (Y,U,V) and the coordinates (x,y).

In step S8, the superpixel affiliation determination section 26 assigns the pixel of interest to the closest initial superpixel for the purpose of determining the initial superpixel to which the pixel of interest is to be affiliated.

In step S9, the superpixel affiliation determination section 26 determines whether or not all pixels have been regarded as the target of interest. In a case where it is determined in step S9 that all the pixels have not been regarded as the target of interest, processing returns to step S7, switches to another pixel of interest, and repeatedly performs processing in a similar manner.

Meanwhile, in a case where it is determined in step S9 that all the pixels have been regarded as the target of interest, processing proceeds to step S10. In step S10, the superpixel information update section 27 regards one initial superpixel as the target of interest, and updates the center value (x,y,Y,U,V). The center value is updated in such a manner as to set the average of pixel values (Y,U,V) of the affiliated pixels and the average of the coordinates (x,y).

In step S11, the superpixel information update section 27 determines whether or not the center values of all initial superpixels have been updated. In a case where it is determined in step S11 that the center values of all the initial superpixels have not been updated, processing returns to step S10, switches to another initial superpixel of interest, and repeatedly performs a center value update.

Meanwhile, in a case where it is determined in step S11 that the center values of all the initial superpixels have been updated, processing proceeds to step S12.

In step S12, the superpixel information update section 27 determines whether or not steps S7 to S9, which constitute the assignment process, and steps S10 and S11, which constitute the update process, have been performed N times. In this instance, for example, setup is performed so that N=1. Thus, in a case where the assignment and update processes have been performed once, it is determined that they have been performed N times.

If sequentially inputted images can be processed in real time, the assignment and update processes may be performed two or more times.

In a case where it is determined in step S12 that the assignment and update processes have not been performed N times, processing returns to step S7 and repeatedly performs the above-described processing. Meanwhile, in a case where it is determined in step S12 that the assignment and update processes have been performed N times, processing is performed to output the superpixel information including the center value of each superpixel and the identification information regarding superpixels to which the pixels included in the input image are to be affiliated. Upon completion of such superpixel information output, the segmentation process terminates.

Inheriting the superpixel information and performing the assignment and update processes based on the inherited superpixel information as described above make it possible to ensure the accuracy of segmentation even when the assignment and update processes are performed only once. That is, the segmentation processing section 11 is able to swiftly perform segmentation of video images.

Performing the assignment and update processes based on the inherited superpixel information is equivalent to performing the assignment and update processes in what is called the time direction.

The foregoing description assumes that the superpixel information regarding a one-frame-preceding past frame is used for inheritance. However, the superpixel information regarding a plurality of past frames may alternatively be used for inheritance.

### <<Feature Amount Calculation>>

### <General Image Feature Amount>

A general image feature amount will now be described.

The general feature amount used for image processing is the feature amount of individual pixels. Therefore, it can be said that the general feature amount used for image processing is a localized feature amount. A local feature amount, which is a localized feature amount, significantly varies with the local waveform of an input image. Therefore, it can be said that the local feature amount is unstable and easily affected, for example, by noise.

In some cases, for the purpose of avoiding unstableness, the local feature amount of a whole frame is totalized to determine a whole-screen feature amount, or the whole frame is divided into a plurality of blocks to totalize the feature amount of the individual blocks and determine a block feature amount. Increasing the number of samples makes it possible to ensure the accuracy of feature amount.

In the above instance, the whole-screen feature amount is such that only one value can be obtained per frame. Therefore, processing based on the whole-screen feature amount cannot be controlled on an individual imaging object basis. Further, the block feature amount is obtained by regularly dividing a frame. Therefore, processing based on the block feature amount cannot be controlled in accordance with the imaged state of an imaging object such as the shape of the imaging object.

Meanwhile, the feature amount calculation section 12 of the image processing device 1 is able to calculate a highly accurate feature amount in accordance with the imaged state of the imaging object such as the shape of the imaging object by totalizing the local feature amount through the use of the superpixel information acquired by segmentation. Calculating a highly accurate feature amount makes it possible to increase the accuracy of later-stage processing such as object recognition.

### <Configuration of Feature Amount Calculation Section>

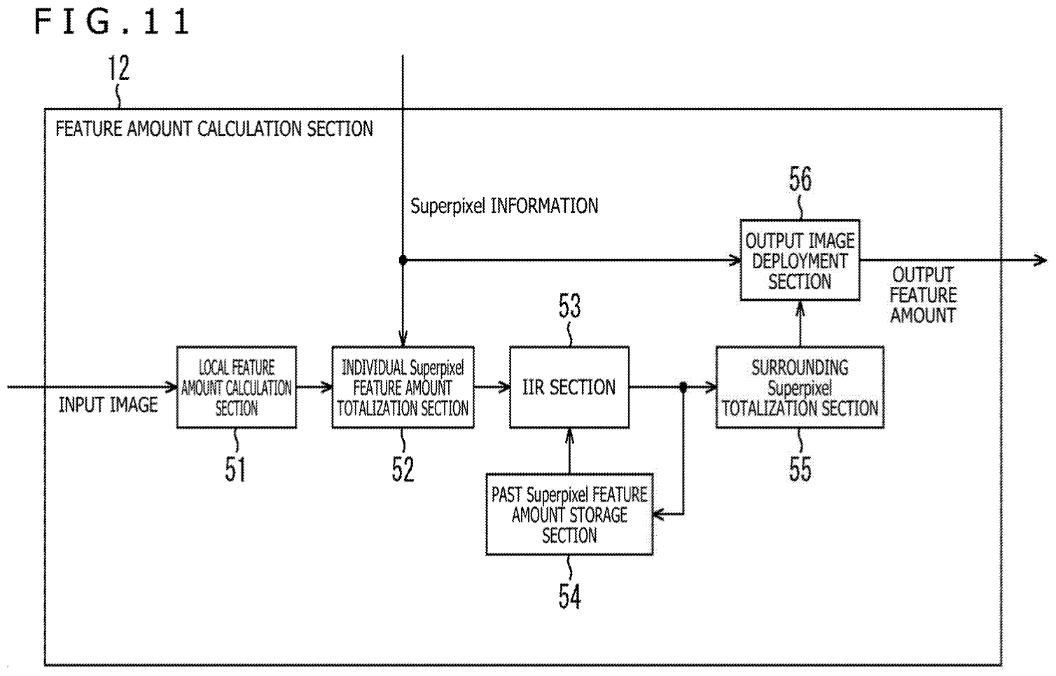

FIG. 11 is a block diagram illustrating a configuration example of the feature amount calculation section 12 depicted in FIG. 1.

The feature amount calculation section 12 includes a local feature amount calculation section 51, an individual superpixel feature amount totalization section 52, an IIR section 53, a past superpixel feature amount storage section 54, a surrounding superpixel totalization section 55, and an output image deployment section 56. Each frame included in a video image is supplied, as the input image, to the local feature amount calculation section 51. Further, the superpixel information outputted from the segmentation processing section 11 is supplied to the individual superpixel feature amount totalization section 52 and the output image deployment section 56.

Based on the input image, the local feature amount calculation section 51 calculates the feature amount of each pixel as a local feature amount. Alternatively, the local feature amount calculation section 51 may calculate the local feature amount of each block containing a predetermined number of pixels, such as 4×4 pixels or 8×8 pixels. For example, the local feature amount calculation section 51 calculates a general feature amount used for image processing, such as a brightness value, a color difference, or a contrast. Information regarding the local feature amount calculated by the local feature amount calculation section 51 is supplied to the individual superpixel feature amount totalization section 52.

Based on the superpixel information supplied from the segmentation processing section 11, the individual superpixel feature amount totalization section 52 identifies a superpixel to which each pixel is to be affiliated, and then totalizes the local feature amount of the pixels affiliated to the same superpixel. For example, information regarding the feature amount of pixels affiliated to the same superpixel and information regarding the number of pixels are gathered on an individual superpixel basis.

In a case where the totalization of local feature amount is terminated, the individual superpixel feature amount totalization section 52 calculates the average value of local feature amount of pixels affiliated to the same superpixel as the superpixel feature amount, which is the feature amount of each superpixel. The superpixel feature amount also includes information regarding, for example, a brightness value, a color difference, or a contrast.

Weighting may be performed on an individual local feature amount basis in order to calculate the superpixel feature amount. For example, weighting can be performed on the local feature amount of each pixel in accordance with a pixel location in a superpixel. This enables the individual superpixel feature amount totalization section 52 to increase the accuracy of the superpixel feature amount.

The superpixel feature amount calculated by the individual superpixel feature amount totalization section 52, which indicates the feature of each superpixel, is supplied to the IIR section 53.

The IIR section 53 uses an IIR filter to perform filter processing on the superpixel feature amount calculated by the individual superpixel feature amount totalization section 52. A past superpixel feature mount stored in the past superpixel feature amount storage section 54 is used for the filter processing. The feature amount of the inheritance-source superpixel retrieved by search at the time of segmentation is used in the above instance.

For example, the variation of an average value in the time direction can be suppressed to achieve stabilization by mixing a one-frame-preceding value with a current frame value for each superpixel feature amount (average value) of the same superpixel. As the filter processing is performed on each superpixel, the size of a memory required for configuring the past superpixel feature amount storage section 54 is as small as the total size of all superpixels (P×Q).

In a case where a high reliability of inheritance is required for each superpixel in the search for the inheritance-source superpixel at the time of segmentation, a feedback ratio indicating the level of feedback of a one-frame-preceding value may be controlled in accordance with the reliability. The reliability of inheritance is determined based, for example, on the accuracy of motion compensation.

More specifically, the filter processing performed by using the IIR filter is a process of feeding a one-frame-preceding average value back to a current frame average value at a predetermined feedback ratio. However, the level of such feedback varies with the reliability of inheritance. In a case where the inheritance is reliable, the superpixel feature amount can be stabilized by feeding back the one-frame-preceding average value at a high feedback ratio.

The IIR section 53 outputs the superpixel feature amount whose variation in the time direction is suppressed to achieve stabilization. The superpixel feature amount outputted from the IIR section 53 is supplied to the surrounding superpixel totalization section 55. Further, the superpixel feature amount outputted from the IIR section 53 is supplied to the past superpixel feature amount storage section 54 and stored for the filter processing of the next frame.

Based on the superpixel feature amount supplied from the IIR section 53, the surrounding superpixel totalization section 55 determines a superpixel correlated with each superpixel by selecting it from the surrounding superpixels within the same frame. As is the case with regions of the same object, a superpixel having a feature amount not differing from the feature amount of a certain other superpixel by more than a threshold value is determined as the correlated superpixel.

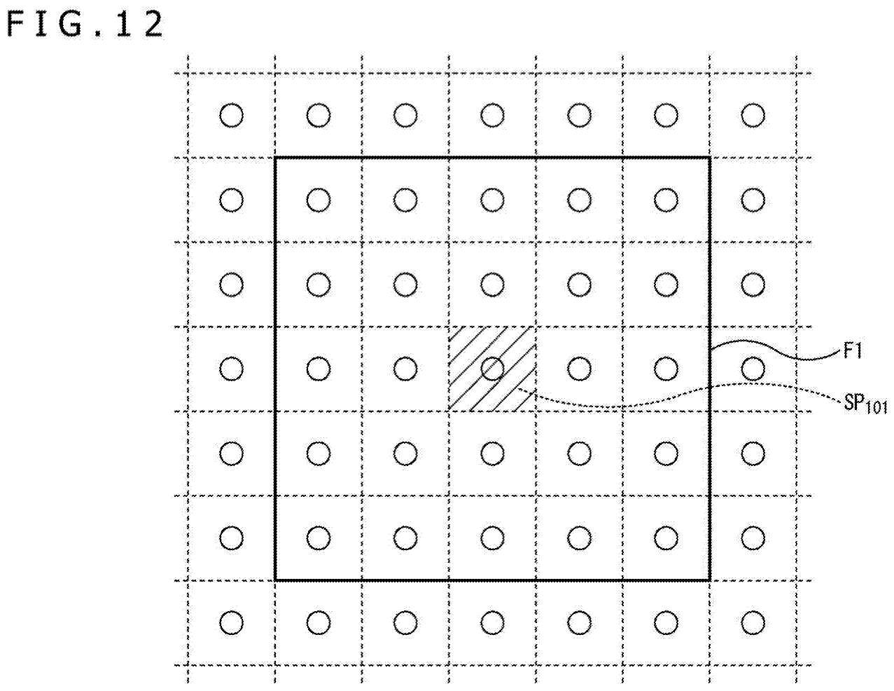

FIG. 12 is a diagram illustrating an example of determining correlated superpixels.

For ease of explanation, the example of FIG. 12 depicts each superpixel as a block-shaped region.

For example, in a case where a hatched superpixel, that is, SP₁₀₁, is regarded as a target of interest, a correlation coefficient indicating the correlation between SP₁₀₁ and each superpixel positioned within a predetermined range centered on SP₁₀₁ is calculated based on the superpixel feature amount. In the example of FIG. 12, the correlation coefficient relative to the superpixels encircled by a border F1 is calculated.

The surrounding superpixel totalization section 55 totalizes (gathers) the superpixel feature amount of superpixels correlated with each superpixel. Further, the surrounding superpixel totalization section 55 performs a predetermined computation based on the totalized superpixel feature amount in order to calculate the feature amount in a wide area representing the range of the correlated superpixels. For example, the average value of the superpixel feature amount is calculated as a wide-area average value representing the feature amount in the wide area.

For example, in a case where all superpixels (other than SP₁₀₁) positioned within the border F1 are correlated with SP₁₀₁ in the example of FIG. 12, the wide-area average value of SP₁₀₁ is determined based on the superpixel feature amount of all the superpixels positioned within the border F1. The surrounding superpixel totalization section 55 functions as a computation section for computing the wide-area average value indicative of the feature amount of each superpixel by performing weighting on the feature amount of the correlated superpixels.

The wide-area average value may be calculated by performing weighting on each superpixel feature amount. For example, performing weighting based on the correlation coefficient relative to a superpixel of interest makes it possible to reduce the influence of the superpixel feature amount of a low-correlated superpixel.

Mixing the feature amount of a certain superpixel with the feature amount of the surrounding superpixels makes it possible to achieve stabilization by suppressing the spatial variation of feature amount.

As for a superpixel to which one-frame-preceding information is not inherited, feature amount interpolation may be performed by using the feature amount of the surrounding superpixels.

Information regarding the wide-area average value of each superpixel whose spatial variation is suppressed to achieve stabilization as described above is supplied from the surrounding superpixel totalization section 55 to the output image deployment section 56.

Based on the wide-area average value of each superpixel, which is supplied from the surrounding superpixel totalization section 55, the output image deployment section 56 calculates the whole-screen feature amount, which is the feature amount of a whole frame. As the amount of information is small, the whole-screen feature amount can be calculated more easily than in a case where the calculation is performed based on the local feature amount of each pixel.

Further, as the feature amount of each pixel, the output image deployment section 56 sets the wide-area average value of a superpixel to which each pixel is affiliated. The output image deployment section 56 outputs the feature amount of each pixel and the whole-screen feature amount to the image processing section 13.

In a case where the output value (feature amount) of each pixel is regarded as the value indicative of the wide-area feature amount of a superpixel to which each pixel is affiliated, the output value changes abruptly at the boundary of a superpixel. In order to avoid such an abrupt output value change, a process may be performed so as to smooth an output value change at the boundary of a superpixel.

For example, a value obtained by mixing the values indicative of the wide-area feature amount of N (e.g., two or four) superpixels surrounding a superpixel to which a pixel is affiliated is outputted as the output value of the pixel instead of outputting, on an as-is basis, the value indicative of the wide-area feature amount of the superpixel to which the pixel is affiliated. This makes it possible to smooth the output feature amount of the pixel. A ratio determined, for example, by performing an internal division based on the center value of each superpixel and the distance to its pixels is used as the ratio of mixing the values indicative of the wide-area feature amount.

Changing the mixing ratio in accordance with the correlation coefficient calculated by the surrounding superpixel totalization section 55 makes it possible to smooth a boundary between similar superpixels without smoothing a boundary between non-similar superpixels affiliated to different objects.

### <Operation of Feature Amount Calculation Section>

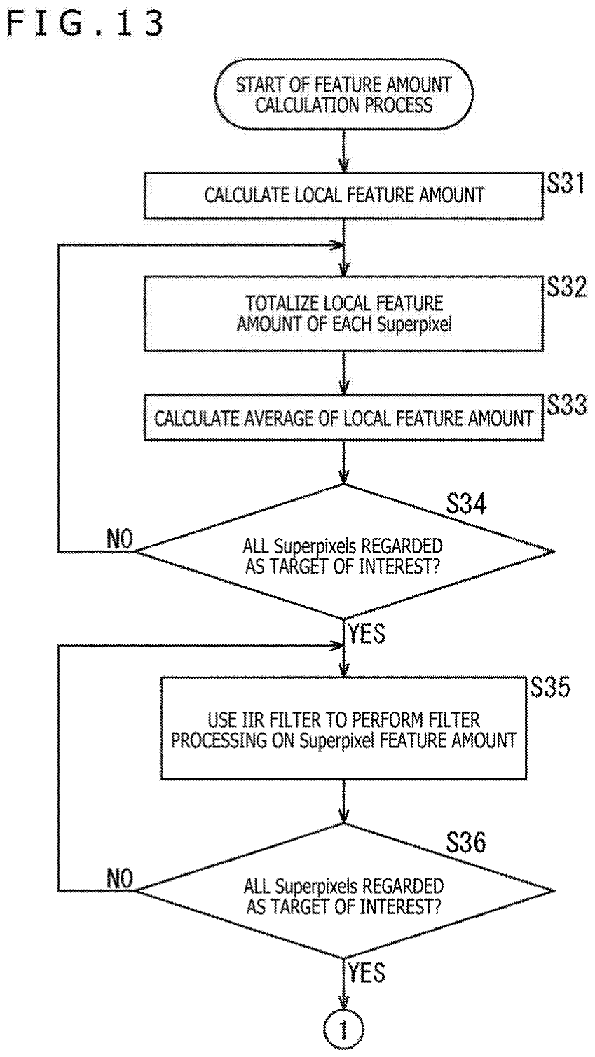

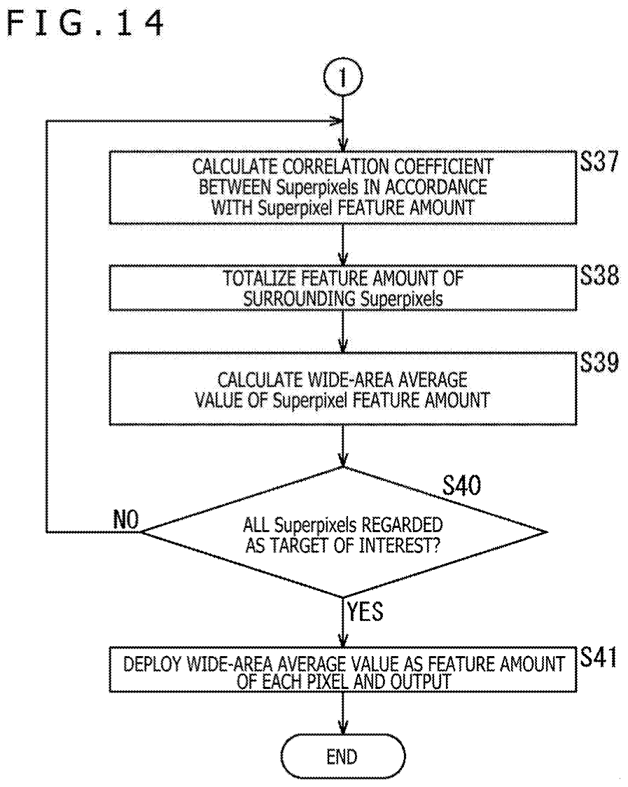

A feature amount calculation process performed by the feature amount calculation section 12 will now be described with reference to the flowcharts of FIGS. 13 and 14.

The process described in FIGS. 13 and 14 is performed each time a frame included in a video image and the superpixel information regarding each superpixel in the frame are inputted.

In step S31, based on the input image, the local feature amount calculation section 51 calculates the feature amount of each pixel as the local feature amount.

In step S32, the individual superpixel feature amount totalization section 52 regards a superpixel as the target of interest, and totalizes the local feature amount of pixels affiliated to the same superpixel.

In a case where the totalization of local feature amount is terminated, the individual superpixel feature amount totalization section 52 calculates, in step S33, the average value of local feature amount of the pixels affiliated to the same superpixel as the superpixel feature amount, which is the feature amount of each superpixel.

In step S34, the individual superpixel feature amount totalization section 52 determines whether or not all superpixels have been regarded as the target of interest. In a case where it is determined in step S34 that all the superpixels have not been regarded as the target of interest, processing returns to step S32, switches to another superpixel of interest, and repeatedly performs processing in a similar manner.

Meanwhile, in a case where it is determined in step S34 that all the superpixels have been regarded as the target of interest, processing proceeds to step S35. In step S35, the IIR section 53 regards a superpixel as the target of interest, and uses an IIR filter to perform filter processing on the superpixel feature amount of the superpixel of interest.

In step S36, the individual superpixel feature amount totalization section 52 determines whether or not all the superpixels have been regarded as the target of interest. In a case where it is determined in step S36 that all the superpixels have not been regarded as the target of interest, processing returns to step S35, switches to another superpixel of interest, and repeatedly performs processing in a similar manner.

Meanwhile, in a case where it is determined in step S36 that all the superpixels have been regarded as the target of interest, processing proceeds to step S37 (FIG. 14).

In step S37, the surrounding superpixel totalization section 55 regards a superpixel as the target of interest, and calculates, based on the superpixel feature amount, the correlation coefficient indicating the correlation between the superpixel of interest and each of superpixels surrounding the superpixel of interest.

In step S38, the surrounding superpixel totalization section 55 determines superpixels having a correlation coefficient equal to or greater than a threshold value by selecting it from the surrounding superpixels, and totalizes the superpixel feature amount of the determined superpixels by performing weighting in accordance with the correlation coefficient.

In step S39, the surrounding superpixel totalization section 55 calculates the wide-area average value based on the totalized superpixel feature amount. The wide-area average value is calculated on an individual superpixel basis.

In step S40, the surrounding superpixel totalization section 55 determines whether or not all the superpixels have been regarded as the target of interest. In a case where it is determined in step S40 that all the superpixels have not been regarded as the target of interest, processing returns to step S37, switches to another superpixel of interest, and repeatedly performs processing in a similar manner.

Meanwhile, in a case where it is determined in step S40 that all the superpixels have been regarded as the target of interest, processing proceeds to step S41. In step S41, the output image deployment section 56 deploys the wide-area average value as the feature amount of each pixel included in the input image. That is, the wide-area average value of a superpixel to which each pixel is affiliated is set as the feature amount of each pixel included in the input image.

The feature amount of each pixel, which is set by using the wide-area average value, and the whole-screen feature amount, which is calculated based on the wide-area average value, are both outputted as the output feature amount to terminate the feature amount calculation process.

Performing filter processing by using the IIR filter as described above makes it possible to ensure the stability of superpixel feature amount in the time direction.

Further, the stability of superpixel feature amount in the spatial direction can be ensured by calculating the correlation coefficient between the superpixels in accordance with the feature amount and then calculating the wide-area average value in accordance with the superpixel feature amount of correlated superpixels.

Furthermore, the whole-screen feature amount, which is the feature amount of a whole frame, can be easily calculated based on the superpixel feature amount.

The foregoing description assumes that the wide-area average value is calculated after filter processing is performed by using the IIR filter. However, an alternative is to calculate the wide-area average value before performing filter processing by using the IIR filter.

### <<Other>>

### <Example Applications>

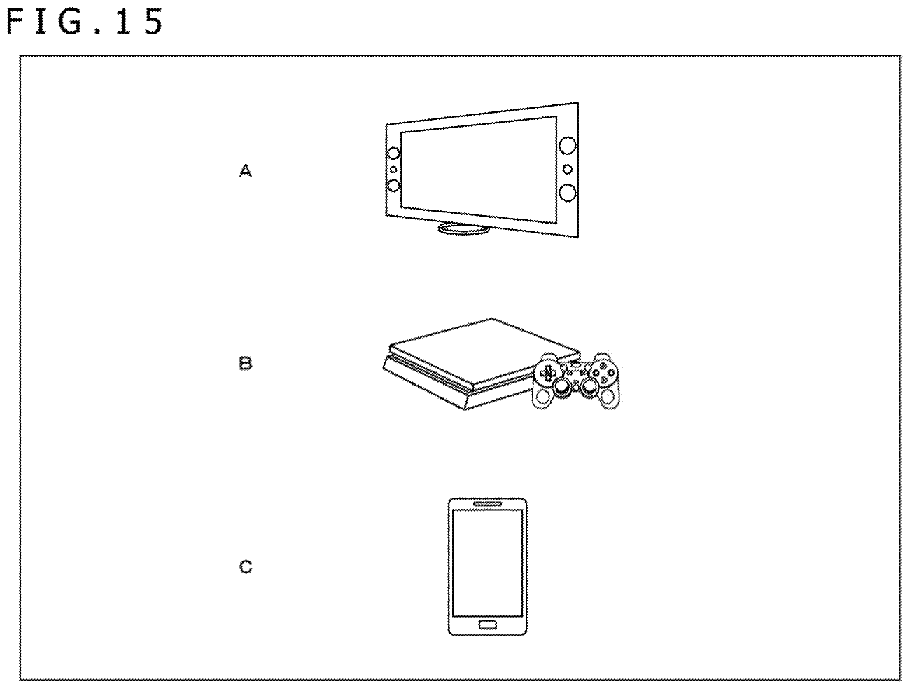

FIG. 15 is a diagram illustrating examples of equipment in which the image processing device is mounted.

The image processing device 1 can be disposed in various kinds of equipment for processing video images, such as a TV set, a gaming machine, and a smartphone or other mobile terminal depicted in A to C of FIG. 15. The image processing device 1 may be disposed in a digital camera, a video camera, a personal computer, and other equipment not depicted in FIG. 15.

The above-described series of processes can be performed by hardware or by software. Allowing predetermined software to be executed, for example, by a CPU implements functional sections having the similar functions to the segmentation processing section 11 depicted in FIG. 3 and the various sections of the feature amount calculation section 12 depicted in FIG. 11.

In a case where the series of processes is to be performed by software, a program included in the software is installed, for example, on a computer incorporated in dedicated hardware or a general-purpose personal computer from a program recording medium.

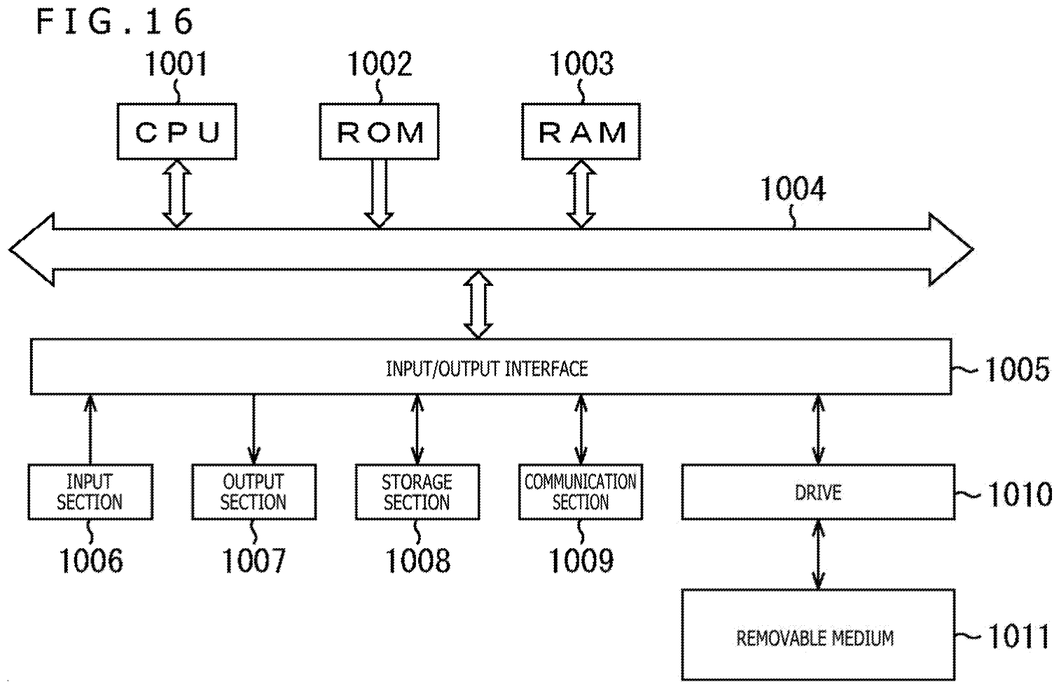

FIG. 16 is a block diagram illustrating an example hardware configuration of a computer that performs the above-described series of processes by executing a program.

A CPU (Central Processing Unit) 1001, a ROM (Read Only Memory) 1002, and a RAM (Random Access Memory) 1003 are interconnected by a bus 1004.

The bus 1004 is further connected to an input/output interface 1005. The input/output interface 1005 is connected to an input section 1006 and an output section 1007. The input section 1006 includes, for example, a keyboard and a mouse. The output section 1007 includes, for example, a display and a speaker. Further, the input/output interface 1005 is also connected to a storage section 1008, a communication section 1009, and a drive 1010. The storage section 1008 includes, for example, a hard disk and a nonvolatile memory. The communication section 1009 includes, for example, a network interface. The drive 1010 drives removable medium 1011.

In the computer configured as described above, the CPU 1001 performs the above-described series of processes, for example, by loading a program stored in the storage section 1008 into the RAM 1003 through the input/output interface 1005 and the bus 1004, and executing the loaded program.

The program to be executed by the CPU 1001 is recorded, for example, on the removable medium 1011 or supplied through a wired or wireless transmission medium such as a local area network, the Internet, or a digital broadcasting system, and then installed in the storage section 1008.

It should be noted that the program to be executed by the computer may perform processing in a chronological order described in this document or perform processing in a parallel manner or at a required time point in response, for example, to a program call.

The advantages described in this document are merely illustrative and not restrictive. The present technology can provide additional advantages.

The embodiments of the present technology are not limited to those described above, and may be variously modified without departing from the scope and spirit of the present technology.

For example, the present technology may be configured for crowd computing in which one function is shared by a plurality of devices through a network in order to perform processing in a collaborative manner.

Further, each step described with reference to the foregoing flowcharts may be not only performed by one device but also performed in a shared manner by a plurality of devices.

Moreover, in a case where a plurality of processes is included in a single step, the plurality of processes included in such a single step may be not only performed by one device but also performed in a shared manner by a plurality of devices.

### <Examples of Combined Configurations>

The present technology may also adopt the following configurations.

(1)

An image processing device including:

a setting section that sets superpixels for frames included in a video image, the superpixels being regions including a plurality of pixels; and

an information setting section that, as information regarding each of the superpixels in a predetermined frame, inherits and sets information regarding a corresponding one of the superpixels in a frame earlier than the predetermined frame.

(2)

The image processing device according to (1), in which the information setting section performs motion compensation by using a motion vector in order to determine the superpixel in the earlier frame, the determined superpixel serving as an information inheritance source.

(3)

The image processing device according to (2), in which the information setting section determines, as the superpixel serving as the information inheritance source, the superpixel in the earlier frame that is positioned closest to a motion-compensated location of the superpixel serving as an information inheritance destination.

(4)

The image processing device according to (3), in which the information setting section selects one of the superpixels within a predetermined range based on the motion-compensated location of the superpixel serving as the information inheritance destination in the earlier frame, and determines the selected superpixel as the superpixel serving as the information inheritance source.

(5)

The image processing device according to (2), in which the information setting section determines the superpixel serving as the information inheritance source in accordance with a relationship between a location of the superpixel serving as an information inheritance destination and a location of each of the superpixels in the earlier frame.

(6)

The image processing device according to (2), in which information regarding the superpixel includes pixel value information determined based on pixel values of pixels included in the superpixel and coordinate information regarding the superpixel.

(7)

The image processing device according to (6), in which the information setting section sets pixel value information included in the information regarding the superpixel serving as the information inheritance source as pixel value information included in the information regarding the superpixel serving as the information inheritance destination, and sets information regarding motion-compensated coordinates of the superpixel serving as the information inheritance source as coordinate information included in the information regarding the superpixel serving as the information inheritance destination.

(8)

The image processing device according to any one of (1) to (7), further including:

a determination section that determines the superpixel to which each of pixels included in the predetermined frame is affiliated; and

an update section that updates the information regarding the superpixel in accordance with information regarding the pixels affiliated to the superpixel.

(9)

The image processing device according to (8), in which the update section outputs, as a segmentation result, the information regarding the superpixel and obtained by performing a single update.

(10)

The image processing device according to (8) or (9), further including:

a feature amount calculation section that calculates a feature amount of the superpixel in accordance with the feature amount of the pixels affiliated to the superpixel.

(11)

The image processing device according to (10), further including:

a filter processing section that performs filter processing by using the feature amount of the superpixel in the predetermined frame and the feature amount of a corresponding one of the superpixels in the earlier frame, and thus calculates the feature amount of the superpixel.

(12)

The image processing device according to (11),

in which the filter processing is a process of feeding the feature amount of the superpixel in the earlier frame back to the feature amount of the superpixel in the predetermined frame, and

in which the filter processing section controls the feedback in accordance with reliability of inheritance of the information regarding the superpixel.

(13)

The image processing device according to (10) to (12), further including:

a computation section that uses the feature amount of surrounding ones of the superpixels to perform weighting on the feature amount of each of the superpixels in accordance with correlations between the feature amounts.

(14)

The image processing device according to (10) to (13), further including:

an output section that outputs an overall feature amount of the predetermined frame, the overall feature amount being calculated based on the feature amount of the superpixel.

(15)

The image processing device according to (14), in which the output section further outputs, as the feature amount of each of the pixels included in the predetermined frame, the feature amount of the superpixel to which each of the pixels is affiliated.

(16)

An image processing method performed by an image processing device, including the steps of:

setting superpixels for frames included in a video image, the superpixels being regions including a plurality of pixels; and

as information regarding each of the superpixels in a predetermined frame, inheriting and setting information regarding a corresponding one of the superpixels in a frame earlier than the predetermined frame.

(17)

A program for causing a computer to perform a process including the steps of:

setting superpixels for frames included in a video image, the superpixels being regions including a plurality of pixels; and

as information regarding each of the superpixels in a predetermined frame, inheriting and setting information regarding a corresponding one of the superpixels in a frame earlier than the predetermined frame.

### REFERENCE SIGNS LIST

1 Image processing device, 11 Segmentation processing section, 12 Feature amount calculation section 13 Image processing section, 21 Motion vector calculation section, 22 Pre-filter section, 23 Temporary center setting section, 24 Past information inheritance section, 25 Past superpixel information storage section, 26 Superpixel affiliation determination section, 27 Superpixel information update section, 51 Local feature amount calculation section, 52 Individual superpixel feature amount totalization section, 53 IIR section, 54 Past superpixel feature amount storage section, 55 Surrounding superpixel totalization section, 56 Output image deployment section

1. An image processing device comprising:
a setting section that sets superpixels for frames included in a video image, the superpixels being regions including a plurality of pixels; and
an information setting section that, as information regarding each of the superpixels in a predetermined frame, inherits and sets information regarding a corresponding one of the superpixels in a frame earlier than the predetermined frame.

2. The image processing device according to claim 1, wherein the information setting section performs motion compensation by using a motion vector in order to determine the superpixel in the earlier frame, the determined superpixel serving as an information inheritance source.

3. The image processing device according to claim 2, wherein the information setting section determines, as the superpixel serving as the information inheritance source, the superpixel in the earlier frame that is positioned closest to a motion-compensated location of the superpixel serving as an information inheritance destination.

4. The image processing device according to claim 3, wherein the information setting section selects one of the superpixels within a predetermined range based on the motion-compensated location of the superpixel serving as the information inheritance destination in the earlier frame, and determines the selected superpixel as the superpixel serving as the information inheritance source.

5. The image processing device according to claim 2, wherein the information setting section determines the superpixel serving as the information inheritance source in accordance with a relationship between a location of the superpixel serving as an information inheritance destination and a location of each of the superpixels in the earlier frame.

6. The image processing device according to claim 2, wherein information regarding the superpixel includes pixel value information determined based on pixel values of pixels included in the superpixel and coordinate information regarding the superpixel.

7. The image processing device according to claim 6, wherein the information setting section sets pixel value information included in the information regarding the superpixel serving as the information inheritance source as pixel value information included in the information regarding the superpixel serving as the information inheritance destination, and sets information regarding motion-compensated coordinates of the superpixel serving as the information inheritance source as coordinate information included in the information regarding the superpixel serving as the information inheritance destination.

8. The image processing device according to claim 1, further comprising:
a determination section that determines the superpixel to which each of pixels included in the predetermined frame is affiliated; and
an update section that updates the information regarding the superpixel in accordance with information regarding the pixels affiliated to the superpixel.

9. The image processing device according to claim 8, wherein the update section outputs, as a segmentation result, the information regarding the superpixel and obtained by performing a single update.

10. The image processing device according to claim 8, further comprising:
a feature amount calculation section that calculates a feature amount of the superpixel in accordance with the feature amount of the pixels affiliated to the superpixel.

11. The image processing device according to claim 10, further comprising:
a filter processing section that performs filter processing by using the feature amount of the superpixel in the predetermined frame and the feature amount of a corresponding one of the superpixels in the earlier frame, and thus calculates the feature amount of the superpixel.

12. The image processing device according to claim 11,
wherein the filter processing is a process of feeding the feature amount of the superpixel in the earlier frame back to the feature amount of the superpixel in the predetermined frame, and
wherein the filter processing section controls the feedback in accordance with reliability of inheritance of the information regarding the superpixel.

13. The image processing device according to claim 10, further comprising:
a computation section that uses the feature amount of surrounding ones of the superpixels to perform weighting on the feature amount of each of the superpixels in accordance with correlations between the feature amounts.

14. The image processing device according to claim 10, further comprising:
an output section that outputs an overall feature amount of the predetermined frame, the overall feature amount being calculated based on the feature amount of the superpixel.

15. The image processing device according to claim 14, wherein the output section further outputs, as the feature amount of each of the pixels included in the predetermined frame, the feature amount of the superpixel to which each of the pixels is affiliated.

16. An image processing method performed by an image processing device, comprising the steps of:
setting superpixels for frames included in a video image, the superpixels being regions including a plurality of pixels; and
as information regarding each of the superpixels in a predetermined frame, inheriting and setting information regarding a corresponding one of the superpixels in a frame earlier than the predetermined frame.

17. A program for causing a computer to perform a process including the steps of:
setting superpixels for frames included in a video image, the superpixels being regions including a plurality of pixels; and
as information regarding each of the superpixels in a predetermined frame, inheriting and setting information regarding a corresponding one of the superpixels in a frame earlier than the predetermined frame.
